(19) United States
(12) Patent Application Publication
(10) Pub. No.: US 2010/0272167 A1
(43) Pub. Date: Oct. 28, 2010

(54) Method and Apparatus for Simplifying a Probabilistic Rate Adaptation Procedure in a Wireless Communication System

(76) Inventors: Yen-Chin Liao, Taipei City (TW); Yung-Szu Tu, Taipei County (TW); Cheng-Hsuan Wu, Taipei City (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/430,893

(22) Filed: Apr. 28, 2009

(51) Int. Cl. H04B 17/00

(52) U.S. Cl. 375/227; 455/67.11

(57) ABSTRACT

The present invention provides a method for simplifying a probabilistic rate adaptation procedure in a wireless communication system, which comprises calculating a conditional probability density function of SNR of a transmitted signal by the probabilistic rate adaptation procedure, to generate an SNR estimation result, taking logarithm on the SNR estimation result to generate a logarithm result, and partitioning SNR values into a plurality of regions according to the logarithm result, to generate a discrete function from the SNR estimation result.

### BACKGROUND OF THE INVENTION

1. Field of the Invention

The present invention relates to a method and apparatus for simplifying a probabilistic rate adaptation procedure in a wireless communication system, and particularly, to a method and apparatus for simplifying computation of the probabilistic rate adaptation procedure via logarithm operation and approximation of step function, leading to low-complexity and low-cost implementation.

2. Description of the Prior Art

Modulation and Coding Scheme, MCS, is a term used within a wireless communication system to specify which of the different modulation and coding parameters is being applied. Different MCSs are classified by indexes; for example, in an IEEE 802.11n system, MCS-15 represents the corresponding transmission applies 64-QAM, 5/6 coding rate, and two possible transmission rates based on bandwidth of 20 MHz or 40 Hz. To enhance transmission efficiency, the system should select an adequate MCS.

In the wireless communication system, a transmission channel is never ideal, and is affected by many factors, such as multi-path effect, fading effect, noise, or interference from other electronic systems. When the transmission environment of the transmission channel is changed, the system must reselect another adequate MCS, to prevent waste of radio resource if the channel can afford a transmission rate higher than the initial rate, or prevent descending throughput if the transmission environment deteriorates.

Since a transmitter of the wireless communication system cannot get information about channel status, the transmitter can only check transmission results, i.e. ACK (Acknowledgement) and NACK (Negative acknowledgement), to determine variation of the transmission environment. In such a situation, the prior art has provided different algorithms, to determine channel status and perform rate adaptation, including Auto Rate Fallback (ARF), Adaptive ARF (AARF), Sample Rate (SR), Onoe, Adaptive Multi Rate Retry (AMRR), Multiband Atheros Driver for WiFi (Madwifi), and Robust Rate Adaptation Algorithm (RRAA) for example. Both ARF and AARF send probe packets, and determine to in-/decrease transmission rate according to detecting results. SR periodically sends probe packets with a transmission rate selected randomly, and determines a transmission rate having the highest throughput for the following transmissions. Onoe transmits packets with a specified transmission rate for a period, and increases transmission rate to the next level if a packet error rate during the period is lower than 10%, or otherwise, decreases the transmission rate. Both AMRR and Madwifi send probe packets, and determine to in-/decrease transmission rate according to receiving status of two consecutive packets. RRAA determines transmission rate according to ACK and receiving status of packets.

Therefore, the prior art rate adaptation methods need to send probe packets or compute transmission quality of a certain period, to update transmission rate. However, if a wireless communication system supporting real-time services applies the above-mentioned methods, low throughput occurs because MCS cannot converge in short time.

The prior art has disclosed another rate adaptation method, a probabilistic rate adaptation approach, by which a probability of SNR (Signal-to-noise Ratio) is updated based on transmission results (i.e. ACK), and MCS can be determined accordingly. In detail, the transmitter updates a conditional probability density function (CPDF) of SNR, so-called SNR soft information, of a current packet according to ACK related to another transmitted packet and SNR soft information of a former packet. Then, the transmitter selects an adequate MCS according to the updated SNR soft information, so as to transmit the next packet with better transmission rate. Operations of the probabilistic rate adaptation approach can be represented by the following algorithm:
Φ={0,1, . . . , (M−1)}, the available MCS rates.
mcs={mcs⁽⁰⁾ mcs⁽¹⁾ . . . mcs^{(N-1)}}, the MCS rates of the last N transmitted packets, and mcs⁽ⁱ⁾εΦ.
ack={ack⁽⁰⁾ ack⁽¹⁾ . . . ack^{(N-1)}}, the acknowledgements of the last N transmitted packets. ack⁽ⁱ⁾=1 if acknowledgement is received; otherwise, ack⁽ⁱ⁾=0.

Given N observed MCS rates and acknowledgements, CPDF of SNR is:

$$\begin{matrix}Pr ( SNR \vert mcs , ack ) = \frac{Pr ( ack \vert mcs , SNR ) Pr ( SNR \vert mcs )}{Pr ( ack \vert mcs )} \\ = C \cdot Pr ( ack \vert mcs , SNR )\end{matrix}$$

$$where$$

$$C = \frac{Pr ( SNR \vert mcs )}{Pr ( ack \vert mcs )}$$

due to independency among the transmitted packets,

$$Pr ( ack \vert mcs , SNR ) = {\prod }_{i = 0}^{N - 1} Pr ( {ack}^{( i )} \vert {mcs}^{( i )} , SNR )$$

For all ack⁽ⁱ⁾ε{0,1}, mcs⁽ⁱ⁾εΦ, and

Pr(ack⁽ⁱ⁾=0|mcs⁽ⁱ⁾,SNR)=1−Pr(ack⁽ⁱ⁾=1|mcs⁽ⁱ⁾,SNR)

The most probable SNR, or the estimated SNR based on the N observations, is

$${SNR}^{( n )} = arg {max}_{s} {\prod }_{i = 0}^{N - 1} Pr ( {ack}^{( i )} \vert {mcs}^{( i )} , SNR = s )$$

Whenever a packet is sent, the probability is updated once, and a new SNR estimate can be derived in a recursive manner,

$${SNR}^{( n )} = arg {max}_{s} {F}^{( n - 1 )} ( s ) Pr ( {ack}^{( n )} \vert {mcs}^{( n )} , SNR = s ) \\ where \\ {F}^{( n - 1 )} ( s ) = {\prod }_{i = 0}^{N - 1} Pr ( {ack}^{( i )} \vert {mcs}^{( i )} , SNR = s ) . \qquad ( Eq . 1 )$$

The estimated SNR is then used to determine the MCS of subsequent transmission.

As can be seen, the probabilistic rate adaptation approach requires complex computation, and is hard to implement.

### SUMMARY OF THE INVENTION

It is therefore a primary objective of the claimed invention to provide a method and apparatus for simplifying a probabilistic rate adaptation procedure in a wireless communication system.

The present invention discloses a method for simplifying a probabilistic rate adaptation procedure in a wireless communication system, which comprises calculating a conditional probability density function of Signal-to-noise Ratio (SNR) of a transmitted signal by the probabilistic rate adaptation procedure, to generate an SNR estimation result, taking logarithm on the SNR estimation result to generate a logarithm result, and partitioning SNR values into a plurality of regions according to the logarithm result, to generate a discrete function from the SNR estimation result.

The present invention further discloses a method for wireless communication system, which comprises transmitting a signal; receiving an acknowledgement (ACK) signal in response to the transmitted signal; calculating a conditional probability density function of Signal-to-noise Ratio (SNR) of the transmitted signal based on the ACK signal to generate an SNR estimation result; and selecting a modulation and coding scheme based on the SNR estimation result.

The present invention further discloses a wireless apparatus, which comprises a transmitter for transmitting a signal; a receiver for receiving an acknowledgement (ACK) signal in response to the transmitted signal; and a processor coupled to the receiver, for calculating a conditional probability density function of Signal-to-noise Ratio (SNR) of the transmitted signal based on the ACK signal to generate an SNR estimation result, and selecting a modulation and coding scheme based on the SNR estimation result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process in accordance with an embodiment of the present invention.

FIG. 2A illustrates a schematic diagram of a measured conditional probability.

FIG. 2B illustrates a schematic diagram of SNR groups corresponding to the measured conditional probability shown in FIG. 2A according to the present invention.

FIG. 3 illustrates a schematic diagram of an ideal SNR-MCS zone in a 2T2R (two transmitter and two receiver) WiFi system.

FIG. 4 illustrates a schematic diagram of a simulated SNR-MCS zone according to the discrete rate adaptation algorithm of the present invention.

FIG. 5 illustrates a schematic diagram of a wireless apparatus in accordance with an embodiment of the present invention.

### DETAILED DESCRIPTION

The present invention can be seen as a discrete rate adaptation approach derived from Eq. 1.

First, take logarithm on Eq. 1, then

$$\begin{matrix}{SNR}^{( n )} = arg {max}_{s} \{ {G}^{( n - 1 )} ( s ) + log Pr ( {ack}^{( n )} \vert {mcs}^{( n )} , SNR = s ) \} \\ and & ( Eq . 2 ) \\ {G}^{( n - 1 )} ( s ) = {\sum }_{i = 0}^{N - 1} log Pr ( {ack}^{( i )} \vert {mcs}^{( i )} , SNR = s ) & ( Eq . 3 ) \\ {G}^{( n )} ( s ) = {G}^{( n - 1 )} ( s ) + log Pr ( {ack}^{( n )} \vert {mcs}^{( n )} , SNR = s ) & ( Eq . 4 )\end{matrix}$$

Therefore, the N*S multiplications in Eq. 1 are converted to N*S additions in Eq. 2.

A logarithm of the conditional probability is approximated by a step function P(s), such that

$$\begin{matrix}log Pr ( {ack}^{( i )} = 1 \vert {mcs}^{( i )} = m , s ) ∼ {P}_{1}^{( m )} ( s ) = \{ \begin{matrix}Δ , & s ∈ {Γ}_{m} \\ - Δ , & s ∉ {Γ}_{m}\end{matrix} \\ and & ( Eq . 5 ) \\ log Pr ( {ack}^{( i )} = 0 \vert {mcs}^{( i )} = m , s ) ∼ {P}_{0}^{( m )} ( s ) = \{ \begin{matrix}- Δ , & s ∈ {Γ}_{m} \\ Δ , & s ∉ {Γ}_{m}\end{matrix} & ( Eq . 6 )\end{matrix}$$

where Γₘ is the SNR region of high conditional probability, i.e.,

Pr(ack⁽ⁱ⁾=1|mcs⁽ⁱ⁾=m,SNR=s)>>0, if sεΓₘ

Pr(ack⁽ⁱ⁾=1|mcs⁽ⁱ⁾=m,SNR=s)<<1, if s∉Γₘ

Therefore, there are M SNR regions Γ_{0,}Γ_{1,} . . . Γₘ for the M available MCS rates, and the M SNR regions Γ_{0,}Γ_{1,} . . . Γₘ can overlap.

Now, SNR values are partitioned into M SNR regions, and the probability of SNR in the same region is treated uniformly. Thus the probability can be represented by an M-point discrete function.

Next, let γₘ be the region of some SNR values where MCS=m should be used for the highest throughput. By labeling γₘ with the index m, Γₘ can be represented by Λₘ, a set including finite integers. As a result, Eq. 3 and Eq. 4 can be converted into a discrete form:

If ack⁽ⁿ⁾=1

G[m]=G[m]+Δ, mεΛ_{mcs}_{⁽ⁿ⁾}

G[m]=G[m]−Δ, m∉Λ_{mcs}_{⁽ⁿ⁾}

Else

G[m]=G[m]−Δ, mεΛ_{mcs}_{⁽ⁿ⁾}

G[m]=G[m]+Δ, m∉Λ_{mcs}_{⁽ⁿ⁾}

End

Thus, the N*S additions are further reduced to N*M additions. The computation is greatly reduced since M<<5.

In short, to simplify computation of SNR soft information, the present invention takes logarithm on the Eq. 1, such that multiplication computations can be converted to addition computations. Then, since logarithm of the conditional probability can be approximated by a step function, the SNR values are partitioned into M SNR regions, and computation can further be reduced. In addition, because each SNR region can be represented by a unit function, storage for the conditional probabilities can be omitted, leading to low-complexity and low-cost implementation.

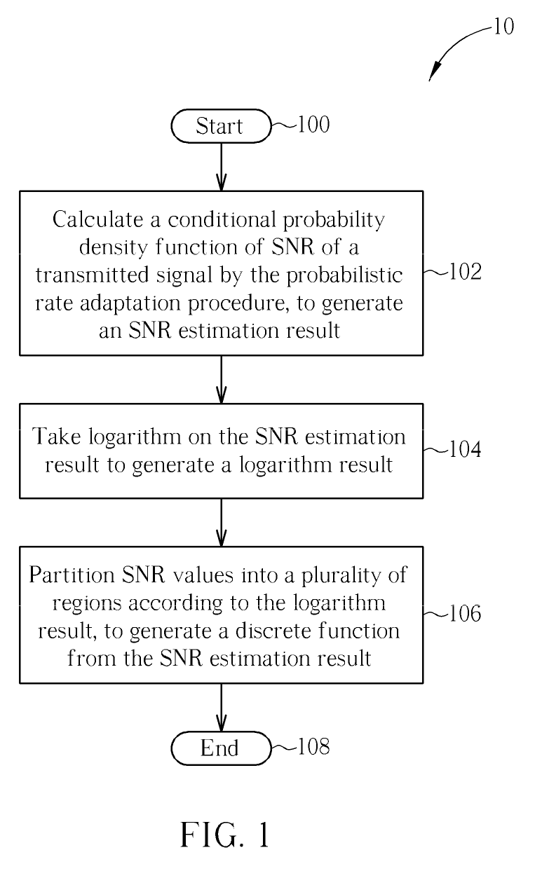

The above-mentioned algorithm can be summarized in a process 10 as shown in FIG. 1. The process 10 is utilized for simplifying a probabilistic rate adaptation procedure in a wireless communication system, and comprises the following steps:

Step 100: Start.

Step 102: Calculate a conditional probability density function of SNR of a transmitted signal by the probabilistic rate adaptation procedure, to generate an SNR estimation result.

Step 104: Take logarithm on the SNR estimation result to generate a logarithm result.

Step 106: Partition SNR values into a plurality of regions according to the logarithm result, to generate a discrete function from the SNR estimation result.

Step 108: End.

Via the present invention, the complexity of computing conditional probability can be reduced, which benefits implementation. For example, as to a 1T1R (one transmitter and one receiver) IEEE 802.11n system, Eq. 5 can be represented by

log Pr(ack⁽ⁱ⁾=1|mcs⁽ⁱ⁾=m,s)˜P₁^{(m)}(s)=2U[m−mcs⁽ⁱ⁾]−1

and Eq. 6 can be represented by

log Pr(ack⁽ⁱ⁾=0|mcs⁽ⁱ⁾=m,s)˜P₀^{(m)}(s)=1−2U[m−mcs⁽ⁱ⁾]

where U[m] is a unit function.

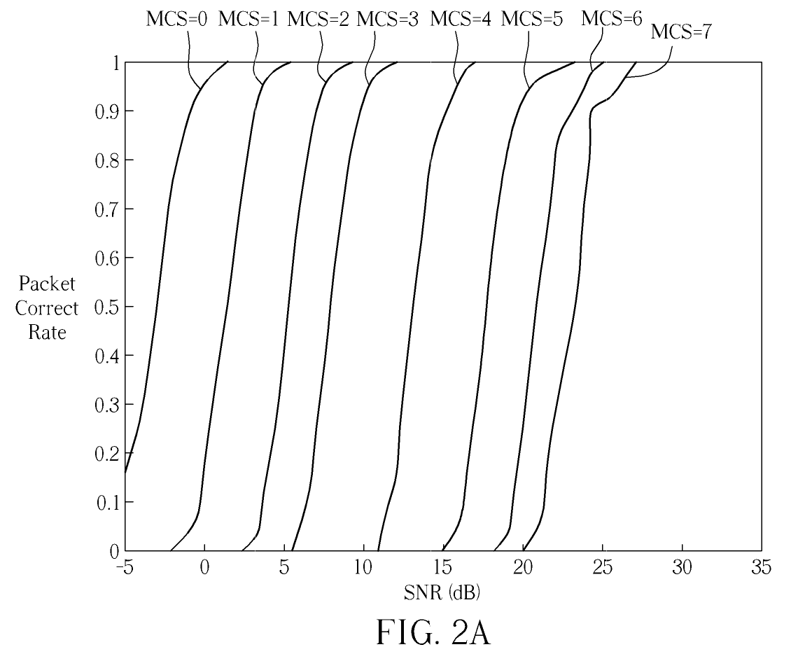

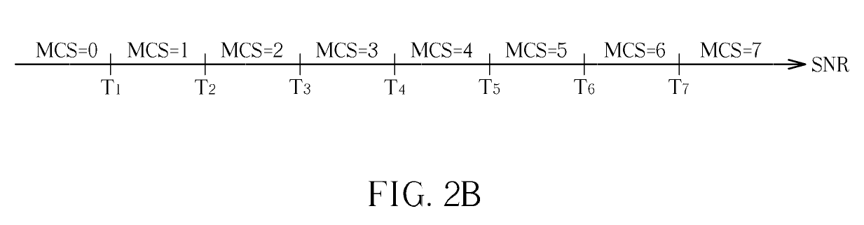

Please refer to FIG. 2A, which illustrates a schematic diagram of Pr(ack⁽ⁱ⁾=1|SNR,MCS) corresponding to MCS0-MCS7, to represent the measured conditional probability. Then, according to the present invention, since each Γ_{0,}Γ_{1,} . . . Γ₇ covers a continuous range of SNR, the discrete set Γₘ for each MCS can be represented by

Γₘ={m, m+1, . . . m+7}

Thus, all the SNR values are partitioned into 8 groups as shown in FIG. 2B, where each group corresponds to a specific MCS for the highest throughput. Therefore, the algorithm becomes

If ack⁽ⁿ⁾=1

G[m]=G[m]+1, m≧mcs⁽ⁿ⁾

G[m]=G[m]−1, m<mcs⁽ⁿ⁾

Else

G[m]=G[m]−1, m≧mcs⁽ⁿ⁾

G[m]=G[m]+1, m<mcs⁽ⁿ⁾

End

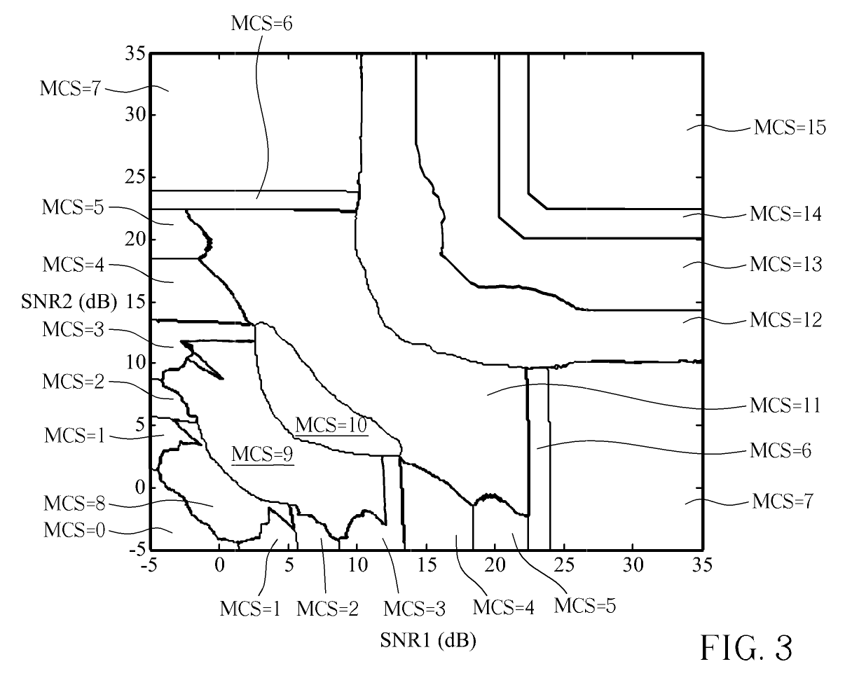

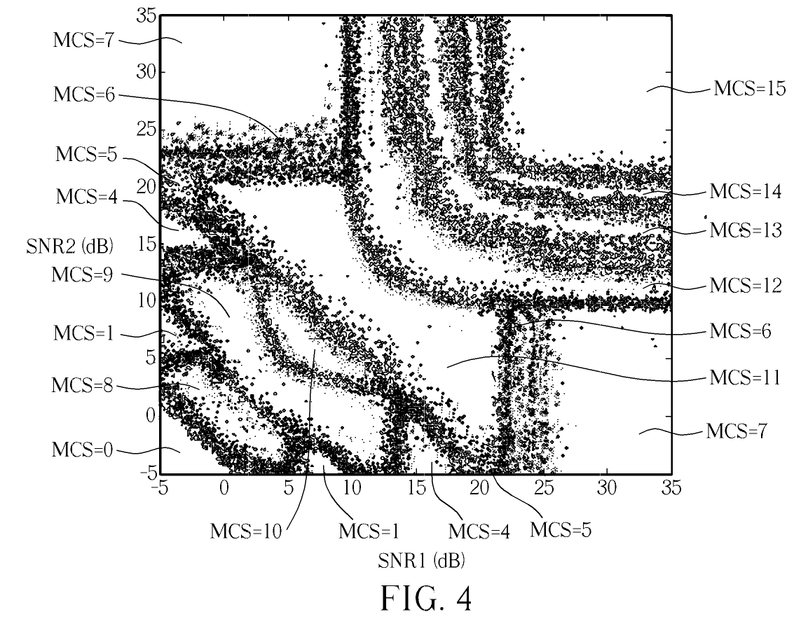

Another example is represented by SNR-MCS zone diagram derived from field trial for 2T2R WiFi system as shown in FIG. 3 and FIG. 4. FIG. 3 illustrates a schematic diagram of an ideal SNR-MCS zone in a 2T2R WiFi system, while FIG. 4 illustrates a schematic diagram of a simulated SNR-MCS zone according to the discrete rate adaptation algorithm of the present invention. In FIG. 4, the adaptation is performed without MCS feedback (MFB) and the adaptation time is fixed to 32-iteration. That is, based on the ACK values of 32 transmitted packets. In the simulated SNR-MCS zone, black points represent wrong MCS; for example, in a region of MCS-15, the points are caused by MCS-0˜14. Therefore, the present invention can select the MCS quickly and accurately.

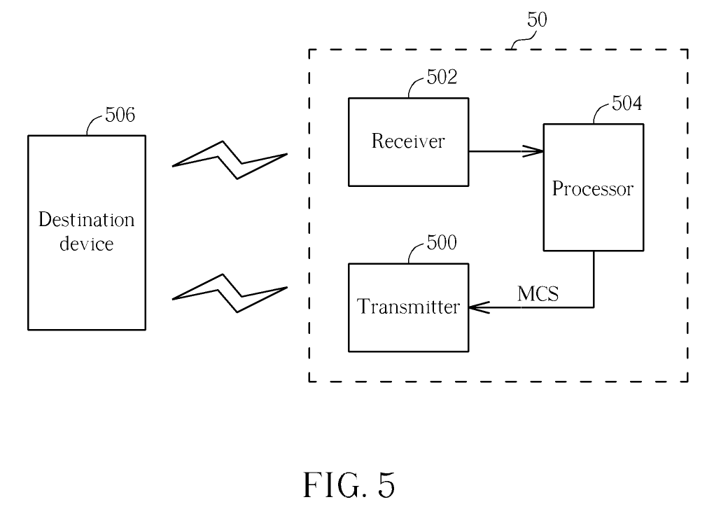

In addition, please refer to FIG. 5, which is a schematic diagram of a wireless apparatus 50 for performing the above algorithm in accordance with. The wireless apparatus 50 can be used in an IEEE 802.11n system or other wireless communication system, and comprises a transmitter 500, a receiver 502 and a processor 504. The transmitter 500 is utilized for transmitting wireless signals to a destination device 506, such as a wireless AP, console, etc. The receiver 502 is utilized for receiving ACKs in response to the transmitted signals from the destination device 506. The processor 504 is utilized for deciding MCS for the transmitter 500 according to the ACKs received by the receiver 502. First, the processor 504 calculates CPDF of SNR of a transmitted signal based on a corresponding ACK, so as to generate an SNR estimation result. Then, the process 504 selects MCS based on the SNR estimation result. The operations of the process 504 can be simplified by the above algorithm; that is, the processor 504 can partition the SNR values into a plurality of regions to generate a discrete function from the SNR estimation result, and select MCS based on the SNR estimation result. Or, in detail, the processor 504 takes logarithm on the SNR estimation result to generate a logarithm result and partitions the SNR values into a plurality of regions according to the logarithm result, to generate a discrete function from the SNR estimation result. The detailed illustration can be obtained in above, and would not be further narrated.

In summary, the present invention can tremendously simplify computation of SNR soft information via logarithm operation and approximation of step function, leading to low-complexity and low-cost implementation.

Those skilled in the art will readily observe that numerous modifications and alterations of the device and method may be made while retaining the teachings of the invention.

What is claimed is:

1. A method for a wireless communication system comprising:
calculating a conditional probability density function of Signal-to-noise Ratio (SNR) of a transmitted signal by the probabilistic rate adaptation procedure, to generate an SNR estimation result;
taking logarithm on the SNR estimation result to generate a logarithm result; and
partitioning the SNR values into a plurality of regions according to the logarithm result, to generate a discrete function from the SNR estimation result.

2. The method of claim 1 further comprising representing each of the plurality of regions by a unit function.

3. The method of claim 1, wherein the step of calculating the conditional probability density function comprises calculating the conditional probability density function based on an acknowledgement (ACK) signal.

4. A method for wireless communication system comprising:
transmitting a signal;
receiving an acknowledgement (ACK) signal in response to the transmitted signal;
calculating a conditional probability density function of Signal-to-noise Ratio (SNR) of the transmitted signal based on the ACK signal to generate an SNR estimation result; and
selecting a modulation and coding scheme based on the SNR estimation result.

5. The method of claim 4, wherein the step of selecting a modulation and coding scheme comprises:
partitioning SNR values into a plurality of regions to generate a discrete function from the SNR estimation result; and
selecting a modulation and coding scheme based on the SNR estimation result.

6. The method of claim 4, wherein the step of calculating a conditional probability density function comprises taking logarithm on the SNR estimation result to generate a logarithm result.

7. The method of claim 6, wherein the step of selecting a modulation and coding scheme comprises partitioning SNR values into a plurality of regions according to the logarithm result, to generate a discrete function from the SNR estimation result.

8. A wireless apparatus, comprising:
a transmitter for transmitting a signal;
a receiver for receiving an acknowledgement (ACK) signal in response to the transmitted signal; and
a processor coupled to the receiver, for calculating a conditional probability density function of Signal-to-noise Ratio (SNR) of the transmitted signal based on the ACK signal to generate an SNR estimation result, and selecting a modulation and coding scheme based on the SNR estimation result.

9. The wireless apparatus of claim 7, wherein the processor further partitions the SNR values into a plurality of regions to generate a discrete function from the SNR estimation result and selects a modulation and coding scheme based on the SNR estimation result.

10. The wireless apparatus of claim 7, wherein the processor further takes logarithm on the SNR estimation result to generate a logarithm result and partitions the SNR values into a plurality of regions according to the logarithm result, to generate a discrete function from the SNR estimation result.
